(19) United States
(12) Patent Application Publication
(10) Pub. No.: US 2023/0120559 A1
(43) Pub. Date: Apr. 20, 2023

(54) PHOTOELECTRIC COMPOSITE CABLE AND COMMUNICATION SYSTEM

(71) Applicant: HUAWEI TECHNOLOGIES CO., LTD., Shenzhen (CN)

(72) Inventors: Jinxing ZHANG, Haikou (CN); Feng TANG, Wuhan (CN); Shenghao LIU, Wuhan (CN)

(73) Assignee: HUAWEI TECHNOLOGIES CO., LTD., Shenzhen (CN)

(21) Appl. No.: 18/145,264

(22) Filed: Dec. 22, 2022

Related U.S. Application Data
(63) Continuation of application No. PCT/CN2021/082227, filed on Mar. 23, 2021.

(30) Foreign Application Priority Data
Jun. 24, 2020 (CN) 202010588796.2

(51) Int. Cl. H01B 11/22; G02B 6/44; G02B 6/38; H01B 7/18

(52) U.S. Cl. CPC H01B 11/22; G02B 6/443; G02B 6/3849; G02B 6/4494; H01B 7/184

(57) ABSTRACT

A photoelectric composite cable and a communication system. The photoelectric composite cable includes an optical unit, an electrical unit, and an outer jacket. The optical unit includes an optical fiber and a ferrule, and the ferrule is sleeved on the optical fiber. The electrical unit includes a wire and a wire jacket, and the wire jacket is sleeved on the wire. The outer jacket wraps outside the optical unit and the electrical unit, and the optical unit and the electrical unit are disposed closely adjacent to each other. An extension direction of the optical unit is consistent with an extension direction of the electrical unit, and at least one convex structure is disposed on an outer wall of the outer jacket.

### CROSS-REFERENCE TO RELATED APPLICATIONS

This application is a continuation of International Application No. PCT/CN2021/082227, filed on Mar. 23, 2021, which claims priority to Chinese Patent Application No. 202010588796.2, filed on Jun. 24, 2020. The disclosures of the aforementioned applications are hereby incorporated by reference in their entireties.

### TECHNICAL FIELD

The embodiments relate to the field of optical cables, a photoelectric composite cable, and a communication system.

### BACKGROUND

With development of a 5th generation (5G) mobile network (and a next generation fixed network, requirements for fiber to the access terminal such as fiber to the antenna, fiber to the camera, fiber to the traffic signal light, fiber to the room, and fiber to the ceiling are too numerous to enumerate. Fiber to the access stub terminal builds a foundation for high-speed and timely communication in the intelligent era, and satisfy demands for massive information and high-quality bandwidth in the intelligent era.

To connect to high-density stub terminals, both optical cables and electrical cables need to be laid, facing problems such as limited laying space and laying for a plurality of times. Therefore, a lightweight photoelectric composite cable with a small size is an example solution for fiber to the stub. In a process of laying a photoelectric composite cable, the photoelectric composite cable needs to pass through a pipe, but resistance when the photoelectric composite cable passes through the pipe is relatively large, affecting efficiency of laying the photoelectric composite cable.

### SUMMARY

The embodiments may provide a photoelectric composite cable and a communication system. A convex structure is disposed on an outer wall of an outer jacket of the photoelectric composite cable, thereby reducing a friction area between the outer jacket and a pipe, reducing resistance when the photoelectric composite cable is laid in the pipe, and improving efficiency of laying the photoelectric composite cable.

According to a first aspect, an embodiment may provide a photoelectric composite cable. The photoelectric composite cable includes an optical unit, an electrical unit, and an outer jacket. The optical unit includes an optical fiber and a ferrule. The ferrule is sleeved on the optical fiber. The electrical unit includes a wire and a wire jacket, and the wire jacket is sleeved on the wire. The outer jacket wraps outside the optical unit and the electrical unit, and the optical unit and the electrical unit are disposed closely adjacent to each other. An extension direction of the optical unit is consistent with an extension direction of the electrical unit, and at least one convex structure is disposed on an outer wall of the outer jacket.

In this implementation, an inner wall of the outer jacket is in close contact with the optical unit and the electrical unit, so that structures of the optical unit and the electrical unit are more stable. A manner in which the optical unit and the electrical unit are used may improve protection for the optical fiber and the wire. The optical unit and the electrical unit are disposed closely adjacent to each other, so that an overall structure of the photoelectric composite cable is more compact. This helps increase laying density of the photoelectric composite cable, and facilitates adaptation of the photoelectric composite cable to a compact connector. In addition, considering that the photoelectric composite cable often needs to pass through a pipe in a laying process, a convex structure is disposed on the outer wall of the outer jacket, thereby reducing a friction area between the outer jacket and the pipe, reducing resistance when the photoelectric composite cable is laid in the pipe, and improving efficiency of laying the photoelectric composite cable.

Optionally, in some possible implementations, a plurality of convex structures are disposed side by side on the outer wall of the outer jacket, and the convex structures are disposed along the extension directions of the optical unit and the electrical unit. In these implementations, an arrangement manner of the plurality of convex structures is provided, improving practicality of this solution.

Optionally, in some possible implementations, a plurality of convex structures are disposed side by side on the outer wall of the outer jacket, and the convex structures are helically wrapped around the outer wall of the outer jacket. In these implementations, another arrangement manner of the plurality of convex structures is provided, improving expansibility of this solution.

Optionally, in some possible implementations, both the ferrule and the wire jacket are of flexible structures. In this case, when the photoelectric composite cable is laid in a pipe, a traction tool needs to be used. Alternatively, both the ferrule and the wire jacket are of rigid structures, and rigidity of the two is similar. Overall rigidity of the photoelectric composite cable is higher, and the photoelectric composite cable can be smoothly pushed in a pipe without a traction tool.

Optionally, in some possible implementations, the electrical unit includes a first electrical unit and a second electrical unit, and the optical unit, the first electrical unit, and the second electrical unit are disposed closely adjacent to each other and around a center of the outer jacket. In these implementations, distances of the optical unit, the first electrical unit, and the second electrical unit from the center of the outer jacket are similar, helping improve overall compactness of the photoelectric composite cable. Correspondingly, distances of the optical unit, the first electrical unit, and the second electrical unit from the outer wall of the outer jacket are similar, helping the outer jacket form good protection for the optical unit, the first electrical unit, and the second electrical unit.

Optionally, in some possible implementations, electrical polarities of the first electrical unit and the second electrical unit are different. For example, the electrical polarity of the first electrical unit is positive, and the electrical polarity of the second electrical unit is negative. A first electrode identification structure and a second electrode identification structure are further disposed in the outer jacket. The first electrode identification structure is disposed near the first electrical unit, and an extension direction of the first electrode identification structure is consistent with an extension direction of the first electrical unit. The second electrode identification structure is disposed near the second electrical unit, and an extension direction of the second electrode identification structure is consistent with an extension direction of the second electrical unit. By disposing the first electrode identification structure and the second electrode identification structure, it is convenient for a user to distinguish between the first electrical unit and the second electrical unit.

Optionally, in some possible implementations, the first electrode identification structure and the second electrode identification structure are color strips with different colors, or the first electrode identification structure and the second electrode identification structure are slotted structures with different cross-sectional shapes. In these implementations, a plurality of implementations of the electrode identification structure are provided, improving flexibility of this solution.

Optionally, in some possible implementations, there are a plurality of optical units and a plurality of electrical units, and the optical units and the electrical units are sequentially disposed closely adjacent to each other and around the center of the outer jacket, helping improve overall compactness of the photoelectric composite cable.

Optionally, in some possible implementations, a groove may be further provided between every two adjacent convex structures on the outer wall of the outer jacket. In this way, a cross-sectional area of the outer jacket is reduced, better helping improve laying density of the photoelectric composite cable. It should be understood that, although a groove may be provided on the outer wall of the outer jacket, a depth of the groove needs to be controlled, so that a safe distance between a bottom of the groove and the optical unit and the electrical unit is maintained, to form good protection for the optical unit and the electrical unit.

Optionally, in some possible implementations, a total quantity of the optical units and the electrical units is the same as and is in a one-to-one correspondence with a total quantity of the convex structures. Correspondingly, a position at which every two adjacent optical units or electrical units are close to each other corresponds to a groove on the outer jacket. It may be understood that a concave may be formed at the position at which every two adjacent optical units or electrical units are close to each other. That the concave position is provided corresponding to the groove clearly has a better wrapping effect than that the optical unit or the electrical unit is disposed corresponding to the groove. By improving compactness of the photoelectric composite cable, the optical unit and the electrical unit may be further well protected.

Optionally, in some possible implementations, the photoelectric composite cable further includes a suspension wire, and the suspension wire and the outer jacket are integrally molded. The suspension wire is configured to hang the outer jacket. By disposing the suspension wire, the photoelectric composite cable is more easily installed in an actual application scenario. In addition, strength of the photoelectric composite cable is improved because the suspension wire and the outer jacket are integrally molded.

Optionally, in some possible implementations, there are a plurality of optical fibers in the optical unit, and there are a plurality of wires in the electrical unit, extending an application scenario of the optical unit and the electrical unit.

Optionally, in some possible implementations, a water blocking layer is further disposed between the ferrule and the optical fiber that are in the optical unit, and a material of the water blocking layer may be ointment, cured resin, or the like. By disposing the water blocking layer, the optical unit has a waterproof effect, and an external force applied to the optical unit may be buffered.

Optionally, in some possible implementations, a high temperature resistance range of the ferrule is 80° C. to 200° C.

Optionally, in some possible implementations, a friction coefficient of the outer jacket is less than or equal to 0.5, and hardness of the outer jacket is greater than or equal to 70 Shore A.

According to a second aspect, the embodiments may provide a communication system, including a first communication device and a second communication device, where the first communication device and the second communication device are connected through a photoelectric composite cable, and the photoelectric composite cable is the photoelectric composite cable according to any one of the implementations of the first aspect. The first communication device outputs an optical signal and an electrical signal, which are transmitted to the second communication device through the photoelectric composite cable. Similarly, the second communication device outputs an optical signal and an electrical signal, which are transmitted to the first communication device through the photoelectric composite cable.

### BRIEF DESCRIPTION OF THE DRAWINGS

FIG. 1 is a diagram of a network architecture;

FIG. 2 is a schematic diagram of a first structure of a photoelectric composite cable according to an embodiment;

FIG. 3(a) is a schematic diagram of a first arrangement manner of a convex structure according to an embodiment;

FIG. 3(b) is a schematic view of a first cross section of an outer jacket in a length direction according to an embodiment;

FIG. 4(a) is a schematic diagram of a second arrangement manner of a convex structure according to an embodiment;

FIG. 4(b) is a schematic view of a second cross section of an outer jacket in a length direction according to an embodiment;

FIG. 5 is a schematic diagram of a structure of an optical unit according to an embodiment;

FIG. 6 is a schematic diagram of a structure of an electrical unit according to an embodiment;

FIG. 7 is a schematic diagram of a second structure of a photoelectric composite cable according to an embodiment;

FIG. 8 is a schematic diagram of a third structure of a photoelectric composite cable according to an embodiment;

FIG. 9 is a schematic diagram of a fourth structure of a photoelectric composite cable according to an embodiment;

FIG. 10 is a schematic diagram of a fifth structure of a photoelectric composite cable according to an embodiment;

FIG. 11 is a schematic diagram of a sixth structure of a photoelectric composite cable according to an embodiment;

FIG. 12 is a schematic diagram of a seventh structure of a photoelectric composite cable according to an embodiment; and

FIG. 13 is a schematic diagram of a structure of a communication system according to an embodiment.

### DETAILED DESCRIPTION OF THE EMBODIMENTS

The embodiments may provide a photoelectric composite cable and a communication system. A convex structure is disposed on an outer wall of an outer jacket of the photoelectric composite cable, thereby reducing a friction area between the outer jacket and a pipe, reducing resistance when the photoelectric composite cable is laid in the pipe, and improving efficiency of laying the photoelectric composite cable.

For ease of understanding, the following describes the embodiments with reference to the accompanying drawings. It is clear that the described embodiments are merely some but not all of the embodiments. All other embodiments obtained by a person of ordinary skill in the art without creative efforts shall fall within the scope of the embodiments.

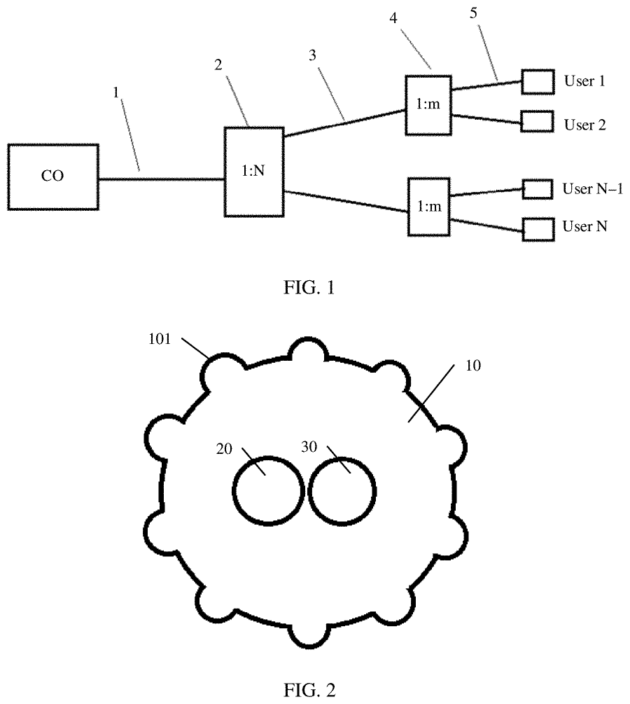

FIG. 1 is a diagram of a network architecture. A flat drop cable may be applied to an optical network of FTTx. FTTx may be fiber to the home (FTTH), fiber to the curb (FTTC), fiber to the premises (FTTP), fiber to the node or neighborhood (FTTN), fiber to the office (FTTO), or fiber to the service area (FTTSA). An FTTH network is used as an example. From a perspective of downstream of a center office (CO), FTTH includes a feeder link 1, a 1:N splitter 2, a home pass 3, a 1:m splitter 4, and at least one branch link 5. A photoelectric composite cable may be applied to the foregoing branch link 5, that is, a home connect in a stub access scenario. Although a network of one type in FTTx structures may be used as an example, another network structure is also applicable. The following describes in detail the photoelectric composite cable.

FIG. 2 is a schematic diagram of a first structure of a photoelectric composite cable according to an embodiment. The photoelectric composite cable includes an outer jacket 10, an optical unit 20, and an electrical unit 30. The outer jacket 10 wraps outside the optical unit 20 and the electrical unit 30. The optical unit 20 and the electrical unit 30 are disposed closely adjacent to each other, and an extension direction of the optical unit 20 is consistent with an extension direction of the electrical unit 30. A convex structure 101 is further disposed on an outer wall of the outer jacket 10, and the convex structure 101 and the outer jacket 10 are integrally molded. A quantity of the convex structures 101 is not limited. It should be understood that a cross section of the convex structure 101 may be a semicircle shown in FIG. 2, or may be another shape such as a rectangle, a triangle, or a trapezoid, which is not limited herein.

It should be noted that a cross section of the outer jacket may be a circle, or may be an oval, which is not limited herein.

In this embodiment, an inner wall of the outer jacket 10 is in close contact with the optical unit 20 and the electrical unit 30, so that structures of the optical unit 20 and the electrical unit 30 are more stable. The optical unit 20 and the electrical unit 30 are disposed closely adjacent to each other, so that an overall structure of the photoelectric composite cable is more compact. This helps increase laying density of the photoelectric composite cable, and facilitates adaptation of the photoelectric composite cable to a compact connector. In addition, considering that the photoelectric composite cable often needs to pass through a pipe in a laying process, the convex structure 101 is disposed on the outer wall of the outer jacket 10, thereby reducing a friction area between the outer jacket 10 and the pipe, reducing resistance when the photoelectric composite cable is laid in the pipe, and improving efficiency of laying the photoelectric composite cable.

There may be a plurality of arrangement manners of the convex structure 101, which are separately described in the following.

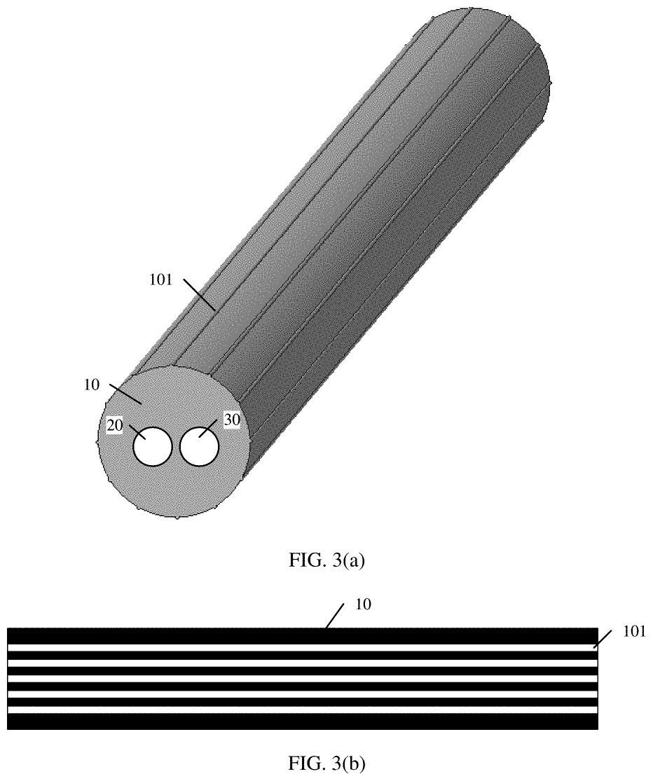

FIG. 3(a) is a schematic diagram of a first arrangement manner of a convex structure according to an embodiment. A plurality of convex structures 101 are disposed side by side on the outer wall of the outer jacket 10. It should be understood that the convex structures 101 may be straight strip structures parallel to each other, as shown in FIG. 3(a). In addition, the convex structures 101 may be alternatively other forms of structures. For example, the convex structures 101 may be wavy strip structures parallel to each other. This is not limited herein. FIG. 3(b) is a schematic view of a first cross section of an outer jacket in a length direction according to an embodiment. It can be seen that the convex structures 101 are parallel to each other and are disposed in an extension direction of the photoelectric composite cable.

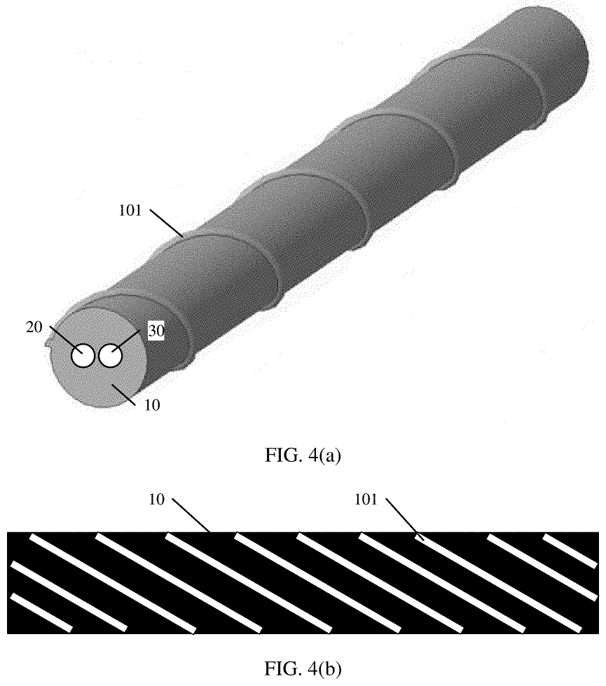

FIG. 4(a) is a schematic diagram of a second arrangement manner of a convex structure according to an embodiment. A plurality of convex structures 101 are disposed side by side on the outer wall of the outer jacket 10, and the convex structures 101 are helically wrapped around the outer wall of the outer jacket 10. FIG. 4(b) is a schematic view of a second cross section of an outer jacket in a length direction according to an embodiment. It can be seen that, different from the convex structure 101 shown in FIG. 3(b), an extension direction of each convex structure 101 shown in FIG. 4(b) has an inclination angle with the extension direction of the photoelectric composite cable.

It should be understood that the embodiments are not limited to the two arrangement manners of the convex structures listed above, any manner in which convex structures are distributed on the outer wall of the photoelectric composite cable falls within the protection scope of the embodiments.

It should be noted that, during construction, the photoelectric composite cable is inevitably curled, twisted, or unevenly stressed. In this case, a part of the photoelectric composite cable that is most stressed is a central position of the photoelectric composite cable. The central position is exactly provided with an optical fiber and a wire, and protection for the optical fiber and the wire is relatively weak. Therefore, protection for the optical fiber and the wire is improved by the photoelectric composite cable using an optical unit and an electrical unit. The following provides further description.

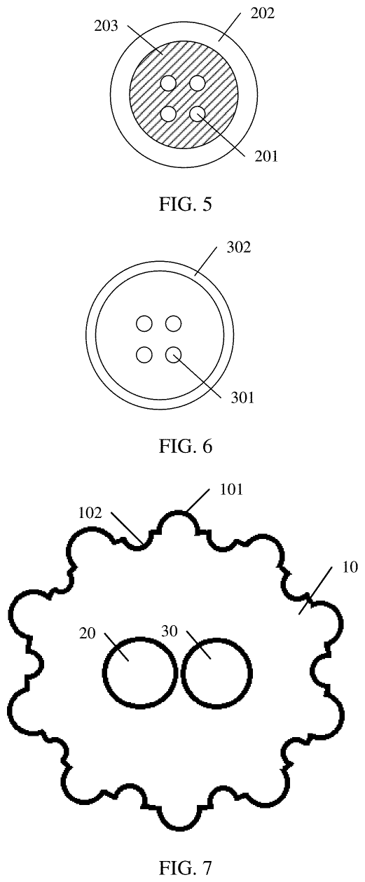

FIG. 5 is a schematic diagram of a structure of an optical unit according to an embodiment. The optical unit 20 includes an optical fiber 201 and a ferrule 202. The ferrule 202 is sleeved on the optical fiber 201 to protect the optical fiber 201. There may be one or more optical fibers 201. Optionally, a water blocking layer 203 may be further disposed between the optical fiber 201 and the ferrule 202, and the water blocking layer 203 has a waterproof effect and may buffer an external force applied to the optical unit 20. A material of the water blocking layer 203 may be ointment or cured resin. A material of the ferrule 202 may be polybutylene terephthalate (PBT), a polyester cured material, or stainless steel. A high temperature resistance range of the ferrule 202 is 80° C. to 200° C.

FIG. 6 is a schematic diagram of a structure of an electrical unit according to an embodiment. The electrical unit 30 includes a wire 301 and a wire jacket 302. The wire jacket 302 is sleeved on the wire 301 to protect the wire 301. There may be one or more wires 301.

It should be noted that, because the optical unit 20 and the electrical unit 30 are disposed closely adjacent to each other, if hardness of the ferrule 202 and hardness of the wire jacket 302 differ greatly, in a process of laying the photoelectric composite cable, extrusion may occur between the optical unit 20 and the electrical unit 30 due to uneven force, affecting stability of the optical unit 20 or the electrical unit 30. Therefore, both the ferrule 202 and the wire jacket 302 are of flexible structures. In this case, when the photoelectric composite cable is laid in a pipe, a traction tool needs to be used. Alternatively, both the ferrule 202 and the wire jacket 302 are of rigid structures, and rigidity of the two is similar. Overall rigidity of the photoelectric composite cable is higher, and the photoelectric composite cable can be smoothly pushed in a pipe without a traction tool.

Optionally, to further reduce resistance when the photoelectric composite cable is laid in the pipe, the outer jacket 10 may use a material with high hardness and a low friction coefficient. For example, a friction coefficient of the outer jacket 10 may be less than or equal to 0.5, and hardness of the outer jacket 10 is greater than or equal to 70 Shore A.

In some possible implementations, to further reduce an overall size of the photoelectric composite cable, the outer jacket 10 may be further improved to some extent. The following provides detailed description.

FIG. 7 is a schematic diagram of a second structure of a photoelectric composite cable according to an embodiment. A plurality of convex structures 101 are disposed side by side on the outer wall of the outer jacket 10. When the photoelectric composite cable is laid in the pipe, the convex structure 101 comes into contact with the pipe. Therefore, a groove 102 may be further provided between every two adjacent convex structures 101 on the outer wall of the outer jacket 10. In this way, a cross-sectional area of the outer jacket 10 is reduced, better helping improve laying density of the photoelectric composite cable. It should be understood that, although a groove 102 may be provided on the outer wall of the outer jacket, a depth of the groove 102 needs to be controlled, so that a safe distance between a bottom of the groove 102 and the optical unit 20 and the electrical unit 30 is maintained, to form good protection for the optical unit 20 and the electrical unit 30. Optionally, a cross section of the groove 102 may be a semicircle shown in FIG. 7, or may be another shape such as a rectangle, a triangle, or a trapezoid, which is not limited herein.

It should be noted that there may be one or more optical units 20, and one or more electrical units. The following provides several typical arrangement manners of the optical unit 20 and the electrical unit 30.

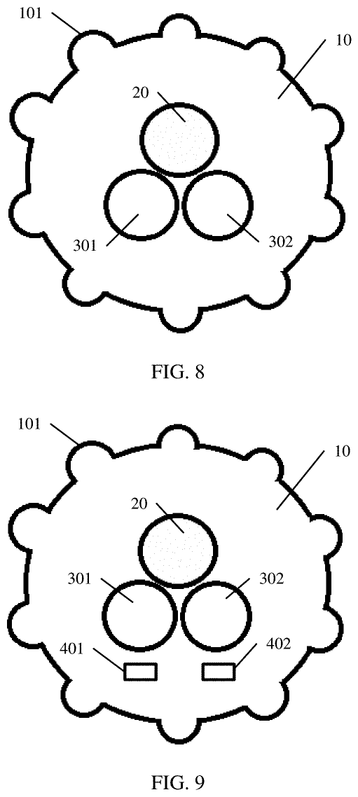

FIG. 8 is a schematic diagram of a third structure of a photoelectric composite cable according to an embodiment. The photoelectric composite cable includes one optical unit 20 and two electrical units (a first electrical unit 301 and a second electrical unit 302). The optical unit 20, the first electrical unit 301, and the second electrical unit 302 are disposed closely adjacent to each other. The optical unit 20, the first electrical unit 301, and the second electrical unit 302 are distributed around a center of the outer jacket 10; in other words, distances of the optical unit 20, the first electrical unit 301, and the second electrical unit 302 from the center of the outer jacket 10 are similar, helping improve overall compactness of the photoelectric composite cable. Correspondingly, distances of the optical unit 20, the first electrical unit 301, and the second electrical unit 302 from the outer wall of the outer jacket 10 are similar, helping the outer jacket form good protection for the optical unit 20, the first electrical unit 301, and the second electrical unit 302.

In a possible implementation, electrical polarities of the first electrical unit 301 and the second electrical unit 302 are different. For example, an electrical polarity of the first electrical unit 301 is positive, and an electrical polarity of the second electrical unit 302 is negative. To help a user distinguish between the electrical polarities of the two electrical units, an electrode identification structure may be further disposed in the outer jacket 10. The electrode identification structure may be implemented in a plurality of manners. For example, FIG. 9 is a schematic diagram of a fourth structure of a photoelectric composite cable according to an embodiment. The electrode identification structure includes a positive electrode color strip 401 and a negative electrode color strip 402 that have different colors. The positive electrode color strip 401 and the negative electrode color strip 402 are wrapped by the outer jacket. The positive electrode color strip 401 is disposed near the first electrical unit 301, and an extension direction of the positive electrode color strip 401 is consistent with an extension direction of the first electrical unit 301. The negative electrode color strip 402 is disposed near the second electrical unit 302, and an extension direction of the negative electrode color strip 402 is consistent with an extension direction of the second electrical unit 302. Alternatively, the electrode identification structure includes slotted structures with different cross-sectional shapes. For example, a cross section of a slotted structure near the first electrical unit 301 is rectangular, and a cross section of a slotted structure near the second electrical unit 302 is circular. It should be understood that, in addition to the electrode identification structures listed above, any other structure that is used to distinguish an electrode of an electrical unit falls within the scope of the embodiments, and is not listed one by one herein. The electrode identification structure is also disposed inside the outer jacket 10, helping form good protection for the electrode identification structure.

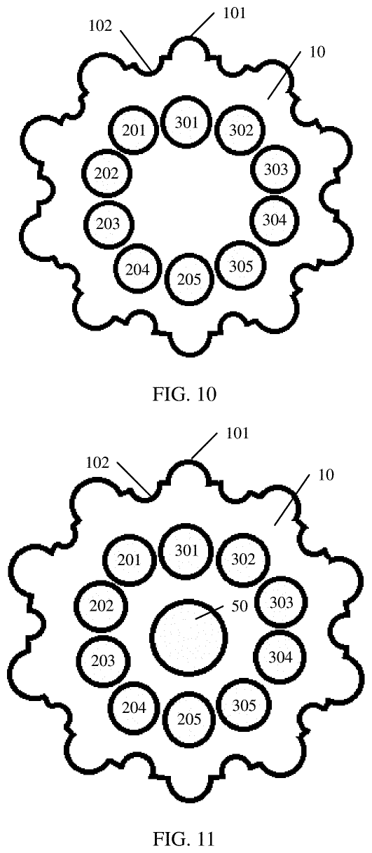

FIG. 10 is a schematic diagram of a fifth structure of a photoelectric composite cable according to an embodiment. There are a plurality of optical units 20 and a plurality of electrical units 30. For example, as shown in FIG. 10, the optical units 20 include an optical unit 201, an optical unit 202, an optical unit 203, an optical unit 204, and an optical unit 205. The electrical units 30 include an electrical unit 301, an electrical unit 302, an electrical unit 303, an electrical unit 304, and an electrical unit 305. The optical units and the electrical units are sequentially disposed closely adjacent to each other, and the optical units and the electrical units are distributed around a center of the outer jacket 10, helping improve overall compactness of the photoelectric composite cable.

In a possible implementation, a total quantity of optical units 20 and electrical units 30 is the same as and is in a one-to-one correspondence with a total quantity of convex structures 101. Each optical unit 20 is disposed collinearly with a convex structure 101 corresponding to the optical unit 20 and the center of the outer jacket 10, and each electrical unit 30 is disposed collinearly with a convex structure 101 corresponding to the electrical unit 30 and the center of the outer jacket 10. Correspondingly, a position at which every two adjacent optical units 20 or electrical units 30 are close to each other corresponds to a groove 102 on the outer jacket 10. It may be understood that a concave may be formed at the position at which every two adjacent optical units 20 or electrical units 30 are close to each other. That the concave position is provided corresponding to the groove 102 clearly has a better wrapping effect than that the optical unit 20 or the electrical unit 30 is disposed corresponding to the groove 102. By improving compactness of the photoelectric composite cable, the optical unit 20 and the electrical unit 30 may be further well protected. It should be noted that the foregoing arrangement manner of the optical units and the electrical units may be that optical units 201 to 205 are sequentially arranged and electrical units 301 to 305 are sequentially arranged, as shown in FIG. 9. In addition, another arrangement manner may be used. For example, the optical units and the electrical units are staggered with each other.

FIG. 11 is a schematic diagram of a sixth structure of a photoelectric composite cable according to an embodiment. Based on the structure shown in FIG. 10, the photoelectric composite cable may further include a reinforcement 50. The reinforcement 50 is wrapped by the outer jacket 10, and an extension direction of the reinforcement 50 is consistent with extension directions of the optical unit 20 and the electrical unit 30. In an embodiment, the reinforcement 50 is disposed in a center of the outer jacket 10, and optical units and electrical units are disposed around the reinforcement 50. By disposing the reinforcement 50, tensile performance of the photoelectric composite cable is improved. Optionally, in some possible implementations, the foregoing reinforcement 50 may be alternatively replaced with the optical unit 20 or the electrical unit 30, so that a similar effect may also be achieved.

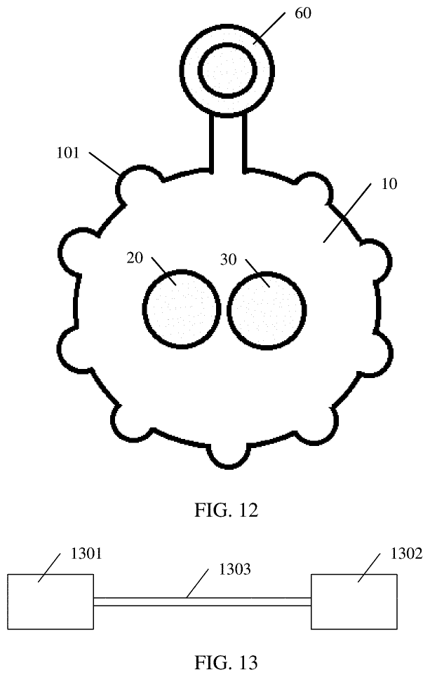

FIG. 12 is a schematic diagram of a seventh structure of a photoelectric composite cable according to an embodiment. In some possible implementations, the photoelectric composite cable needs to be laid in a mounting groove, suspended on a ceiling, or the like. To facilitate suspension of the photoelectric composite cable, the photoelectric composite cable may further include a suspension wire 60. The suspension wire 60 and the outer jacket 10 are integrally molded, and the suspension wire 60 is configured to hang the outer jacket 10. By disposing the suspension wire 60, the photoelectric composite cable is more easily installed in an actual application scenario. In addition, strength of the photoelectric composite cable is improved because the suspension wire 60 and the outer jacket 10 are integrally molded. Optionally, the suspension wire 60 may alternatively use any one or any combination of a single steel wire, a stranded steel wire, an aramid yarn, a glass yarn, a glass yarn reinforcement rod, an aramid yarn reinforcement rod, or the like to improve tensile performance of the suspension wire 60.

The foregoing describes the photoelectric composite cable, and the following describes a communication system. FIG. 13 is a schematic diagram of a structure of a communication system according to an embodiment. The communication system includes a first communication device 1301 and a second communication device 1302. The first communication device 1301 and the second communication device 1302 are connected through a photoelectric composite cable 1303. The photoelectric composite cable 1303 may be the photoelectric composite cable described in any one of the foregoing embodiments in FIG. 2 and FIG. 7 to FIG. 12. An optical signal and an electrical signal that are output by the first communication device 1301 may be transmitted to the second communication device 1302 through the photoelectric composite cable 1303. Similarly, an optical signal and an electrical signal that are output by the second communication device 1302 may also be transmitted to the first communication device 1301 through the photoelectric composite cable 1303.

The foregoing descriptions are merely implementations, but are not intended to limit the scope of the embodiments. Any variation or replacement readily figured out by a person skilled in the art shall fall within the scope of the embodiments.

1. A photoelectric composite cable, comprising:
an optical unit, wherein the optical unit comprises an optical fiber and a ferrule, and the ferrule is sleeved on the optical fiber;
an electrical unit, wherein the electrical unit comprises a wire and a wire jacket, and the wire jacket is sleeved on the wire; and
an outer jacket, wherein the outer jacket wraps outside the optical unit and the electrical unit, the optical unit and the electrical unit are disposed closely adjacent to each other, and an extension direction of the optical unit is consistent with an extension direction of the electrical unit; and at least one convex structure is disposed on an outer wall of the outer jacket.

2. The photoelectric composite cable according to claim 1, further comprising: a plurality of convex structures disposed side by side on the outer wall of the outer jacket and disposed along the extension directions of the optical unit and the electrical unit.

3. The photoelectric composite cable according to claim 1, further comprising:
a plurality of convex structures disposed side by side on the outer wall of the outer jacket and helically wrapped around the outer wall of the outer jacket.

4. The photoelectric composite cable according to claim 1, wherein the ferrule and the wire jacket are of rigid structures, and rigidity of the ferrule and the wire jacket match each other; or
the ferrule and the wire jacket are of flexible structures.

5. The photoelectric composite cable according to claim 1, wherein the electrical unit further comprises:
a first electrical unit; and
a second electrical unit, and the optical unit, the first electrical unit, and the second electrical unit are disposed closely adjacent to each other and around a center of the outer jacket.

6. The photoelectric composite cable according to claim 1, further comprising:
a plurality of optical units; and
a plurality of electrical units, wherein the optical units and the electrical units are sequentially disposed closely adjacent to each other and around the center of the outer jacket

7. The photoelectric composite cable according to claim 1, wherein a groove is provided between every two adjacent convex structures on the outer wall of the outer jacket.

8. The photoelectric composite cable according to claim 1, further comprising:
a plurality of optical fibers in the optical unit; and
a plurality of wires in the electrical unit.

9. The photoelectric composite cable according to claim 1, further comprising a water blocking layer is-disposed between the ferrule and the optical fiber, and a material of the water blocking layer is ointment or cured resin.

10. The photoelectric composite cable according to claim 1, wherein a high temperature resistance range of the ferrule is 80° C. to 200° C.

11. The photoelectric composite cable according to claim 1, wherein a friction coefficient of the outer jacket is less than or equal to 0.5, and hardness of the outer jacket is greater than or equal to 70 Shore A.

12. A communication system, comprising:
a first communication device configured to output an optical signal and an electrical signal; and
a second communication device configured to receive the optical signal and the electrical signal, wherein the first communication device and the second communication device are connected through a photoelectric composite cable,
the photoelectric composite cable comprises:
an optical unit, wherein the optical unit comprises an optical fiber and a ferrule sleeved on the optical fiber,
an electrical unit, wherein the electrical unit comprises a wire and a wire jacket, and the wire jacket is sleeved on the wire, and
an outer jacket, wherein the outer jacket wraps outside the optical unit and the electrical unit, the optical unit and the electrical unit are disposed closely adjacent to each other, and an extension direction of the optical unit is consistent with an extension direction of the electrical unit; and at least one convex structure is disposed on an outer wall of the outer jacket.

13. The communication system according to claim 12, further comprising:
a plurality of convex structures disposed side by side on the outer wall of the outer jacket and disposed along the extension directions of the optical unit and the electrical unit.

14. The communication system according to claim 12, further comprising:
a plurality of convex structures are disposed side by side on the outer wall of the outer jacket and helically wrapped around the outer wall of the outer jacket.

15. The communication system according to claim 12, wherein the ferrule and the wire jacket are of rigid structures, and rigidity of the ferrule and the wire jacket match each other; or
the ferrule and the wire jacket are of flexible structures.

16. The communication system according to claim 12, wherein the electrical unit further comprises:
a first electrical unit; and
a second electrical unit, and the optical unit, the first electrical unit, and the second electrical unit are disposed closely adjacent to each other and around a center of the outer jacket.

17. The communication system according to claim 12, further comprising:
a plurality of optical units; and
a plurality of electrical units, and the optical units and the electrical units are sequentially disposed closely adjacent to each other and around the center of the outer jacket

18. The communication system according to claim 12, wherein a groove is provided between every two adjacent convex structures on the outer wall of the outer jacket.

19. The communication system according to claim 12, further comprising:
a plurality of optical fibers in the optical unit; and
a plurality of wires in the electrical unit.

20. The communication system according to claim 12, further comprising:
a water blocking layer is disposed between the ferrule and the optical fiber, wherein a material of the water blocking layer is ointment or cured resin.
